(19) United States
(12) Patent Application Publication
(10) Pub. No.: US 2008/0195868 A1
(43) Pub. Date: Aug. 14, 2008

(54) Rollback-Resistant Code-Signing

(75) Inventors: Nadarajah Asokan, Espoo (FI); Lauri Paatero, Helsinki (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/673,722

(22) Filed: Feb. 12, 2007

(51) Int. Cl. H04L 9/00

(52) U.S. Cl. 713/176

(57) ABSTRACT

A code signature methodology that allows recovery from incorrectly signed software while preventing rollbacks is described herein. When software is signed, the code signature is based not only on the current version of executable code and information corresponding to the current version of executable code, but also includes a history value based on a previous version of the executable code. Each history value is unknown until each version of the software is validly signed. Thus, the code signature technique allows a signing entity to continue using the same signing key even after recovering from an attack, can be used with and without pre-configured trust roots, and allows a device to upgrade from one version of software to another version of the software while skipping intermediate versions.

### FIELD OF THE INVENTION

The invention relates generally to authentication and verification of versions of software. More specifically, the invention provides methods and systems that utilize a code-signing scheme that allows recovery from incorrectly signed software while preventing rollbacks to older versions of the software.

### BACKGROUND OF THE INVENTION

Code signing is a popular method used to enable a device to verify the authenticity and/or integrity of a piece of software. An example of code signing is the Symbian Signed program. A code signature is used to represent that the entity that signed a piece of software, a.k.a., the code, has approved or verified that software. In addition, if the signature verification key is linked to a pre-installed trust root, then the device attempting to execute the software can decide whether or not to trust the code based on the level of trust of the trust root to which it is linked.

One standard assumption in the art is that code signing is done in a secure place and that suitable screening mechanisms have been applied before a piece of code is signed. Thus, it is assumed that unauthorized software will never be signed. In reality, however, the logistics of code signing are problematic. It is possible that an attacker or other malicious entity could surreptitiously place an unauthorized version of the software into the authorized entity's signing process and get the unauthorized version signed using the authorized entity's credentials. Thus, while unauthorized versions of software may occasionally get signed, the authorized entity eventually detects this and releases a new, properly signed, authorized version of the software or update.

Prior art solutions have attempted, without success, to prevent a device from being tricked into installing an older unauthorized version of software after a newer, authorized version of the software has been installed. One attempted method of preventing such “rollback” is to put a version number in each code signature. However, this solution is not ideal because an attacker could insert a higher version number when it gets the unauthorized version signed. Thus, in order to recover from the malicious update, the signer must change its signing key, and update all devices on which the malicious software is installed so that each device trusts the corresponding signature verification key. Although this is feasible (but cumbersome) when the devices have pre-installed trust roots, it is not feasible in other scenarios.

Code signing may also be used to ensure continuity, i.e., the device will install the software and remember the signature verification key used to verify the code signature. While the software is being used, the software may create new resources (e.g., files) or be assigned some resource (e.g., a cryptographic key). When a purported new version of the same software arrives, the new version is given access to the resources owned by the old version, only if it is signed by the same key that signed the old version. One example of such a scenario is in the Java MIDP security architecture. However, such solutions are not rollback-resistant.

A solution proposed to the general problem of supporting continuity across version upgrades is to embed a new signature verification key in each version of the software. This key may be used to verify the signature on the next version. However, once an attacker or malicious entity manages to get an unauthorized software version signed, that entity has effectively hijacked the software forever. The legitimate signer can no longer recover because the legitimate signer does not know the signing key that can be used to sign the next version.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, aspects of the present invention are directed to a code signature methodology that allows recovery from incorrectly signed software while preventing rollbacks, allows a signing entity to continue using the same signing key even after recovering from an attack, can be used with and without pre-configured trust roots, and allows a device to upgrade from one version of software to another version of the software while skipping intermediate versions.

According to an illustrative aspect, a code signing entity performs a computer-assisted method to sign software by hashing executable code corresponding to a version of a software to create a first hash, hashing secondary information corresponding to the version of the software to create a second hash, and, when the version of the software is an initial version of the software, creating a third hash based on a predetermined value, otherwise identifying a preexisting third hash based on a previous version of the software. The device performing the method then signs the version of the software based on the first hash, second hash, and third hash, and stores the signature on one or more computer readable media for distribution with the version of the software. The code signing entity may be a data processing device, hardware, software, firmware, or any other appropriate means.

According to another illustrative aspect, a receiving device performs a computer assisted method to validate a received software package corresponding to a version of a software by identifying from the software package a code signature and an executable software corresponding to the version of the software, determining a validation hash by decrypting the code signature using a public key of an entity from which the software package is believed received, and creating an independent hash based on the executable software, secondary information corresponding to the version of the software, and information corresponding to a previous version of the software. The receiving device determines that the executable software is validated only when the validation hash matches the independent hash. The validation may be performed by a data processing device, hardware, software, firmware, or any other appropriate means.

Other aspects of the invention may include code signing devices, code verification devices, mobile terminals, and the like. These and other aspects and illustrative features are described in more detail below.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an operating environment according to one or more illustrative aspects described herein.

FIG. 2 illustrates a code signature process according to one or more illustrative aspects described herein.

FIG. 3 illustrate a code validation process according to one or more illustrative aspects described herein.

FIG. 4 illustrates a methodology that may be used to create code signatures for different versions of a software according to one or more illustrative aspects described herein.

FIG. 5 illustrates example values over three versions of software according to one or more illustrative aspects described herein.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

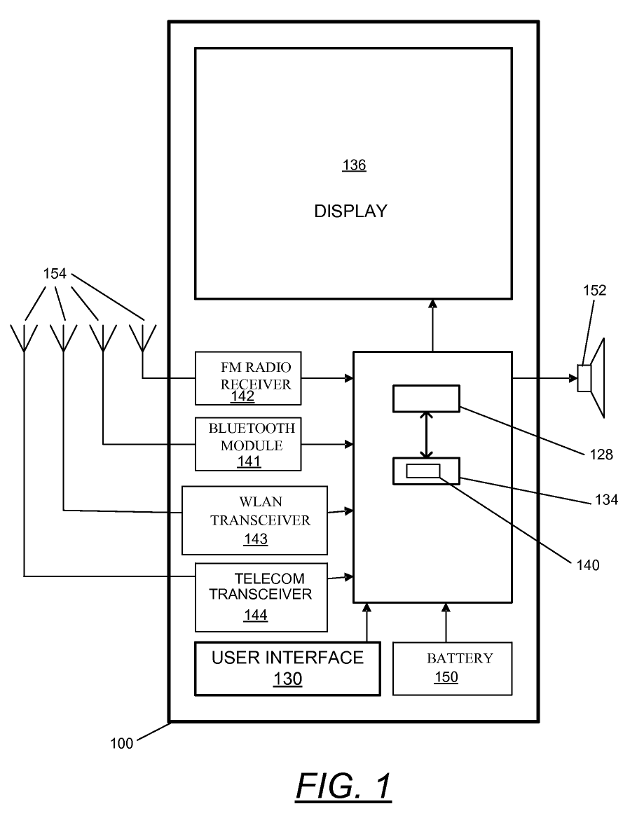

FIG. 1 depicts an illustrative operating environment of a data processing device, here mobile terminal (MT) 100. MT 100 may include processor 128 connected to user interface 130, memory 134 and/or other storage, and display 136. MT 100 may also include battery 150, speaker 152 and antenna(s) 154. User interface 130 may further include a keypad, touch screen, voice interface, one or more arrow keys, joy-stick, data glove, mouse, roller ball, touch screen, display screen, and/or other human-computer interface mechanism(s).

Computer executable instructions and data used by processor 128 and other components within mobile terminal 100 may be stored in a computer readable memory 134. The memory 134 may be implemented with any combination of read only memory modules or random access memory modules, optionally including both volatile and nonvolatile memory and optionally being detachable. Software 140 may be stored within memory 134 and/or other storage to provide instructions to processor 128 for enabling mobile terminal 100 to perform various functions. Alternatively, some or all of the computer executable instructions of the mobile terminal 100 may be embodied in hardware or firmware (not shown).

Mobile terminal 100 may be configured to send and receive transmissions based on the Bluetooth standard, through a specific Bluetooth module 141. Additionally, mobile device 112 may also be configured to receive, decode and process transmissions through FM/AM radio receiver 142, wireless local area network (WLAN) transceiver 143, and telecommunications transceiver 144. In one aspect of the invention, mobile terminal 100 may receive radio data stream (RDS) messages. Mobile terminal 100 may be equipped with additional and/or different receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Each receiver may be physical or logical in that hardware may be combined to provide a single receiver that receives and interprets multiple formats and transmission standards, as desired. That is, each receiver in a mobile terminal device may share parts or subassemblies with one or more other receivers in the mobile terminal device, or each receiver may be an independent subassembly.

One or more aspects of the invention may be usable on any data processing device on which software is validated and/or executed, including but not limited to, a desktop computer, a laptop computer, a palmtop, portable, and/or handheld computer, a tablet computer, a media player, personal digital assistants, smart phones, personal communication devices, a router, a server, a network appliance (e.g., a router or a gateway), a navigation device, or any other consumer electronic device or embedded computing device. Software validation and/or authentication may be accomplished, in part, through the use of digital signatures.

When signing software, it is beneficial that once a device installs a newer authorized version of the software, it cannot be tricked into installing an older unauthorized version, even though the latter has a valid signature. FIG. 2 shows a typical code signature data flow process. Reference numbers preceded by ‘D’ refer to data, whereas reference numbers preceded by ‘P’ refer to processes.

Initially, a signing entity creates executable software D201. The signing entity may be a software developer or other organization or entity producing software D201. The executable software is typically object code which may be executed on a receiving device. The executable software may be a game, an application program, a software utility, or any other software that can execute on the device on which it is received and/or attempting to execute.

Hash process P203 hashes the software D201. That is, P203 receives the software D201 as input, hashes the software D201, and outputs a hash D205 of the software D201. As used herein, the verb ‘hash’ refers to any value or set of values that corresponds to an input, and is preferably a substantially one-way, collision-free function, such as a SHA256, GOST, HAVAL256 hash, and the like. Less strong hashes may also or alternatively be used, e.g., MD5, SHA1, or the like. Given enough storage space, the input itself could even be used as the corresponding value.

Signature process P207 signs the software. That is, process P207 receives the hashed software D205 as input, signs hashed software D205, and outputs signed hashed software D209. D209 is also referred to herein as the code signature, or just signature. Process P207 may “sign” the hash D205 by encrypting hash D205 using the signing entity's private key of a public key/private key pair (for example, RSA asymmetric encryption). Security certificates are preferably issued by a certification authority, but such is not necessary depending on desired security levels. Other code signing techniques may alternatively be used.

Packaging Process P211 then packages the software and signature. That is, process P211 receives code signature D209 and software D201 as input, and outputs software package D213 which includes both the original software D201 and signature D209. Package D213 may subsequently be distributed to devices as desired. Package D213, e.g., may be a ZIP file, a self-extracting executable file, or any other data package that can be executed, parsed, or otherwise interpreted by a device on which it is received.

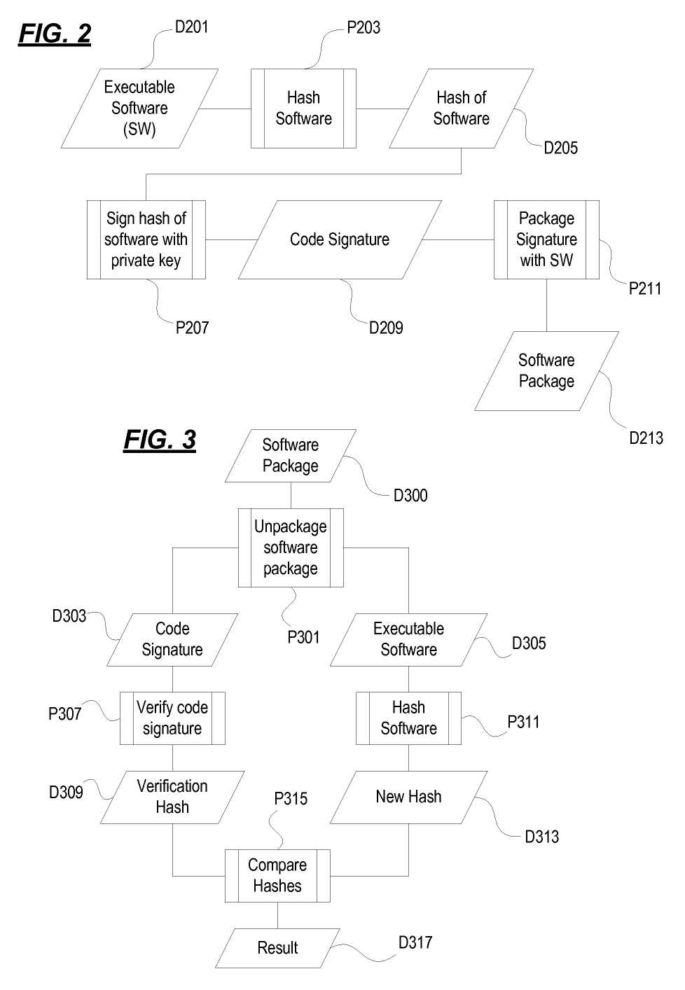

FIG. 3 illustrates the data flow on a recipient device when the recipient or other user desires to validate a received software package D300, e.g., determine whether software package D300 is the same as software package D213. A recipient or user, as used herein, may refer to a receiving computer or other data processing device, such as mobile terminal 100, a human user, or any other entity desiring to authenticate and/or validate received software package D300. MT 100 is used as the receiving user for illustrative purposes herein. When MT 100 receives software package D300, the MT 100 unpackages software package D300 in process P301, which outputs code signature D303 and executable software D305. That is, process P301 splits the software package into two separately analyzable parts—the software itself, and the code signature.

In verification process P307, MT 100 verifies received code signature D303 by decrypting code signature D303 using a public key of the expected signing entity. That is, MT 100 has an expectation regarding the identity of the signing entity, and MT 100 uses that expected signing entity's public key to verify the code signature. If the code was signed (i.e., encrypted) by that expected entity, then the decryption process will mirror the encryption process to yield an unencrypted hash that matches the independently created hash discussed below. If the code was not signed by the expected entity, then the verification process will yield a hash that does not match the independently created hash discussed below. Upon decryption of code signature D303, process P307 outputs verification hash D309.

FIG. 3 describes signature verification for RSA signatures, where the hash can be extracted from the signature. Alternative signature verification methodologies might not extract the hash from the signature, but instead send new hash D313 as input to the verify code signature procedure P307. The output of P307 may be a Boolean value (i.e., “valid” or “invalid”) that is produced as the result of the verification process in such an alternative.

MT 100, in hash process P311, independently re-hashes the executable software D305 using the same algorithm used by the signing entity. Such algorithm or algorithms are separately shared between the signing entity and the receiving user, e.g., according to accepted standards, preexisting agreements, etc. Process P311 outputs independent hash D313. MT 100, in process P315, compares verification hash D309 with independent hash D313, and outputs result D317. When the two hashes match, result D317 indicates that the received software package D300 is successfully validated. When the two hashes do not match, the software package D300 is not validated, e.g., because it is corrupt, was provided by a malicious entity, or for some other unknown reason. In any event, MT 100 will only execute software D305 upon successful validation as identified by result D317.

According to various aspects described herein, in order to make it difficult for malicious entities to attempt to create, forge, or falsify a code signature, the code signature of a specific version of software might include not only the hash of the executable code of that version, but might also include a hash of or be further based on other information associated with that version of the software. For example, the additional information may include a random number or nonce value (as used herein, “random” also includes pseudo-random values generated by a data processing device). The code signature may further be based on information associate with a known valid previous version of the software.

According to an illustrative aspect, a code signature may include a history value that represents a commitment of a previous version of the software, e.g., hashes based on the previous version of the software. That is, the code signature of each version of software is based in a meaningful way (i.e., more than just by increasing a version number) on the previous version of the software, e.g., by including a hash based on information from the previous version of the software. In this manner, when a device accepts the code signature of a certain version N of the software and installs it, it will never accept a version M of the software that was signed before version N was signed. This is because, according to an aspect, the history value of acceptable future signatures includes a commitment to data from version N. At the time version M was signed, the data to be used in version N is not known and cannot be predicted. The code signature process thus creates a semi-recursive signature algorithm.

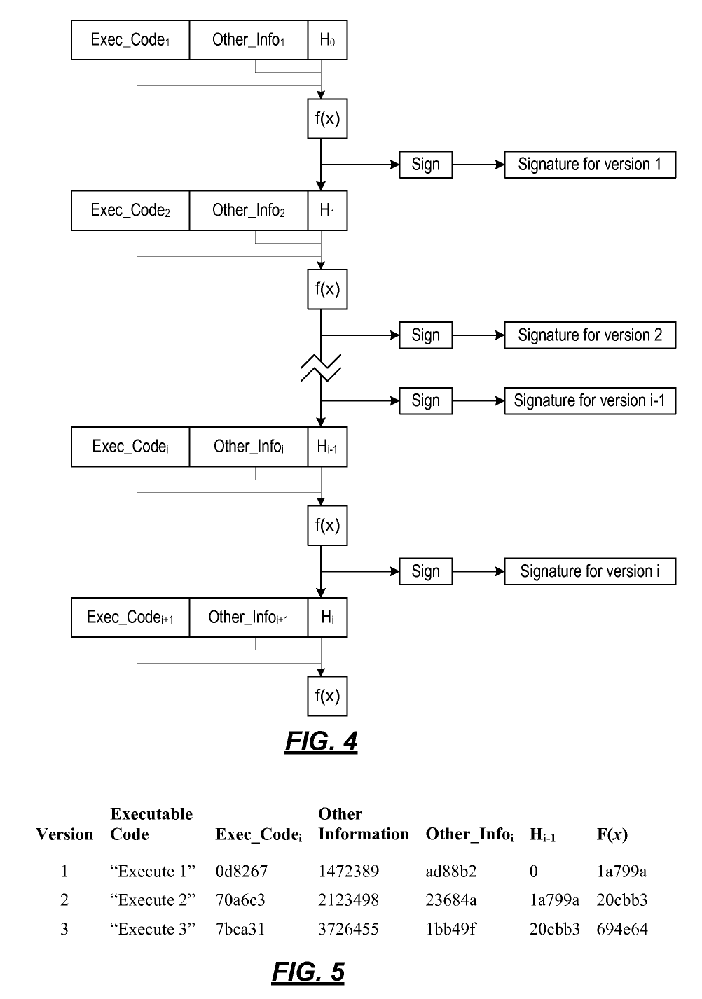

FIG. 4 illustrates a data process that may be used to create code signatures for different versions of a piece of software (or code) according to one or more illustrative aspects. In FIG. 4, Hᵢ represents a history value for version i of the software, where Hᵢ=f(x)=f(Excc_Codeᵢ, Other_Infoᵢ, Hᵢ₋₁). f(x) is any suitable hash, as discussed above, Excc_Codeᵢ is a hash of the executable code of version i of the software, Other_Infoᵢ is a hash of additional data or other secondary information related to version i of the software (e.g., application name, identifier, nonce value, and/or random number, etc.). Because Hᵢ is based on Hᵢ₋₁, H₀ must be predefined. Any known, selected or predetermined value may be used for H₀, e.g., H₀=0. According to an illustrative aspect, in order to ensure that Hᵢ is unpredictable at the time that Hⱼ is created, where j<i, Other_Infoᵢ might also include or be based on a new random value associated with version i of the software. According to an alternative aspect, Exec_Codeᵢ and/or Other_Infoᵢ might not be hashed prior to inclusion in f(x), but rather may be concatenated or otherwise combined with Hᵢ₋₁ prior to input into f(x).

Each device that receives a version i of a software package signed in the herein-described manner contains further instructions (e.g., via software, hardware, or firmware) to only execute the software upon successful validation using the process described in FIG. 3 and based on the received values for Exec_Codeᵢ, Other_Infoᵢ, and Hᵢ₋₁. Thus, using the methodology described herein and illustrated in FIG. 4, once a device has accepted version i of the software, in order for it to accept a new version k (k>i), in addition to the pair (Exec_Codeₖ, Other_Infoₖ) and the signature on Hₖ, it should also be provided with the the set of pairs {Exec_Codeⱼ, Other_Infoⱼ} for all intermediate versions j=i+1, . . . , k−1. The device already has Exec_Codeⱼ, Other_Infoᵢ, and Hᵢ. It can reconstruct the chain all the way from Hᵢ₊₁ to Hₖ and then verify the signature on Hₖ.

Using the above-described methods and systems implementing the methods (e.g., using software, hardware, or firmware), with or without pre-configured trust roots, a signing entity can ensure that it can recover from incorrectly signed software while preventing rollbacks. Aspects described herein further allow the signing entity to continue using the same signing key even after recovering from a malicious attack, because other information is not compromised. In addition, a device can upgrade from one version to another while skipping intermediate versions. That is, a device need not install each intermediate version between the presently installed version on the device and the current version when the intermediate history values are provided with the installation package. The installing device verifies the history value from the version that it last installed. If an attacker's signed version was signed before the device's latest version signed, the attacker cannot produce a history chain that starts from the device's last accepted hash value but ends in the attacker's signed hash value.

According to various alternative aspects, each history value may include the history values for all previous versions of the software. In such a scenario, a version i of the software will include O(i) history (hash) values, or may include Exec_Code and Other_Info values for all previously authorized versions of the software.

FIG. 5 illustrates an example of the above-described code signing technique over three versions of some piece of software. “Executable Code” represents the actual executable software (minus the quotation marks). “Other Information,” in this example, is the version number concatenated with a random number selected to correspond with each version, and x is the concatenation of Exec_Codeᵢ, Other_Infoᵢ, and Hᵢ. Exec_Codeᵢ, Other_Infoᵢ, Hᵢ, and f(x), with the exception of H₀, represent the first six alphanumeric characters of the resultant SHA256 hash of Executable Code, Other Information, and x, respectively. When concatenated to create each xᵢ, only the characters shown in FIG. 5 are used (i.e., the entire SHA256 hash is not used, only the first six characters are used).

The code signing and code verification/validation devices, techniques, methods, and concepts described herein may be performed by any appropriate means, including a data processing device, computer-assisted method, software, hardware, and/or firmware. One or more aspects of the invention may be embodied in computer-usable data and/or computer-executable instructions, such as in one or more program modules, executed by one or more computers or other devices, such as MT 100. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We Claim:

1. One or more computer readable media storing computer readable instructions that, when executed, perform a method comprising:
a) receiving a software package corresponding to a version of a software;
b) identifying from the software package a code signature and an executable software corresponding to the version of the software;
c) determining a validation hash by decrypting the code signature using a public key of an entity from which the software package is believed received;
d) creating an independent hash based on the executable software, secondary information corresponding to the version of the software, and information corresponding to a previous version of the software; and
e) determining that the executable software is validated only when the validation hash matches the independent hash.

2. The computer readable media of claim 1, wherein the secondary information comprises a random number.

3. The computer readable media of claim 1, wherein the information corresponding to the previous version of the software comprises a hash based on executable code corresponding to the previous version of the software, secondary information corresponding to the previous version of the software, and a history value corresponding to a version of software prior to the previous version of the software.

4. The computer readable media of claim 1, said method further comprising installing the executable software only upon determining that the executable software is validated, and otherwise preventing the installation of the executable software.

5. The computer readable media of claim 1, wherein creating the independent hash comprises recreating one or more hashes associated with intervening versions of the software between the version of the software and a presently installed version of the software.

6. The computer readable media of claim 1, wherein each hash is a substantially one-way, collision-free function.

7. A computer-assisted method, comprising:
a) receiving a software package corresponding to a version of a software;
b) identifying from the software package a code signature and an executable software corresponding to the version of the software;
c) determining a validation hash by decrypting the code signature using a public key of an entity from which the software package is believed received;
d) creating an independent hash based on the executable software, secondary information corresponding to the version of the software, and information corresponding to a previous version of the software; and
e) determining that the executable software is validated only when the validation hash matches the independent hash.

8. The computer-assisted method of claim 7, wherein the secondary information comprises a random number.

9. The computer-assisted method of claim 7, wherein the information corresponding to the previous version of the software comprises a hash based on executable code corresponding to the previous version of the software, secondary information corresponding to the previous version of the software, and a history value corresponding to a version of software prior to the previous version of the software.

10. The computer-assisted method of claim 7, further comprising installing the executable software only upon determining that the executable software is validated, and otherwise preventing the installation of the executable software.

11. The computer-assisted method of claim 7, wherein creating the independent hash comprises recreating one or more hashes associated with intervening versions of the software between the version of the software and a presently installed version of the software.

12. The computer-assisted method of claim 7, wherein each hash is a substantially one-way, collision-free function.

13. An apparatus, comprising:
a processor controlling at least some operations of the apparatus; and
memory storing computer executable instructions that, when executed by the processor, configure the apparatus to:
a) hash executable code corresponding to a version of a software to create a first hash;
b) hash secondary information corresponding to the version of the software to create a second hash;
c) when the version of the software is an initial version of the software, create a third hash based on a predetermined value, otherwise to identify a preexisting third hash based on a previous version of the software;
d) sign the version of the software based on the first hash, second hash, and third hash; and
e) store the signature on one or more computer readable media for distribution with the version of the software.

14. The apparatus of claim 13, wherein the secondary information comprises a random number.

15. The apparatus of claim 13, wherein step d) comprises configuring the apparatus to create a fourth hash based on the first hash, second hash, and third hash, and to subsequently sign the fourth hash.

16. The apparatus of claim 13, wherein the apparatus is further configured to create the preexisting third hash according to a)-c) for a version of software to which the third hash corresponds.

17. The apparatus of claim 13, wherein storing the signature comprises storing with the signature, first and second hashes associated with all previous versions of the software.

18. The apparatus of claim 13, wherein each hash is a substantially one-way, collision-free function.

19. An apparatus, comprising:
a processor controlling at least some operations of the apparatus; and
memory storing computer executable instructions that, when executed by the processor, configure the apparatus to:
a) receive a software package corresponding to a version of a software;
b) identify from the software package a code signature and an executable software corresponding to the version of the software;
c) determine a validation hash by decrypting the code signature using a public key of an entity from which the software package is believed received;
d) create an independent hash based on the executable software, secondary information corresponding to the version of the software, and information corresponding to a previous version of the software; and
e) determine that the executable software is validated only when the validation hash matches the independent hash.

20. The apparatus of claim 19, wherein the secondary information comprises a random number.

21. The apparatus of claim 19, wherein the information corresponding to the previous version of the software comprises a hash based on executable code corresponding to the previous version of the software, secondary information corresponding to the previous version of the software, and a history value corresponding to a version of software prior to the previous version of the software.

22. The apparatus of claim 19, further configured to install the executable software only upon determining that the executable software is validated, and otherwise the apparatus prevents the installation of the executable software.

23. The apparatus of claim 19, wherein creating the independent hash comprises configuring the apparatus to recreate one or more hashes associated with intervening versions of the software between the version of the software and a presently installed version of the software.

24. The apparatus of claim 19, comprising a mobile terminal.

25. The apparatus of claim 19, wherein each hash is a substantially one-way, collision-free function.

26. An apparatus, comprising:
a processor controlling some operations of the apparatus;
means for receiving a software package corresponding to a version of a software;
means for identifying from the software package a code signature and an executable software corresponding to the version of the software;
means for determining a validation hash by decrypting the code signature using a public key of an entity from which the software package is believed received;
means for creating an independent hash based on the executable software, secondary information corresponding to the version of the software, and information corresponding to a previous version of the software; and
means for determining that the executable software is validated only when the validation hash matches the independent hash.

27. The apparatus of claim 26, further comprising means for installing the executable software only upon determining that the executable software is validated, and otherwise preventing the installation of the executable software.

28. The apparatus of claim 26, wherein the information corresponding to the previous version of the software comprises a hash based on executable code corresponding to the previous version of the software, secondary information corresponding to the previous version of the software, and a history value corresponding to a version of software prior to the previous version of the software.

29. A computer-assisted method, comprising:
a) receiving a software package corresponding to a version of a software;
b) identifying from the software package a code signature and an executable software corresponding to the version of the software;
c) determining a validation hash by decrypting the code signature using a public key of an entity from which the software package is believed received;
d) creating an independent hash based on the executable software, secondary information comprising a random number corresponding to the version of the software, and information corresponding to a previous version of the software, said information corresponding to the previous version of the software comprising a hash based on executable code corresponding to the previous version of the software, secondary information corresponding to the previous version of the software, and a history value corresponding to a version of software prior to the previous version of the software; and
e) determining that the executable software is validated only when the validation hash matches the independent hash,
wherein each hash is a substantially one-way, collision-free function.

30. The computer-assisted method of claim 29, wherein creating the independent hash comprises recreating one or more hashes associated with intervening versions of the software between the version of the software and a presently installed version of the software.
